(19) United States
(12) Patent Application Publication
(10) Pub. No.: US 2026/0074536 A1
(43) Pub. Date: Mar. 12, 2026

(54) METHODS AND APPARATUS TO IMPLEMENT CURRENT SENSORS

(71) Applicant: Texas Instruments Incorporated, Dallas, TX (US)

(72) Inventors: Divya Kaur, Delhi (IN); Subrato Roy, Bengaluru (IN); Karthikeya Kodur, Bengaluru (IN); Santhosh Kumar Srinivasan, Bengaluru (IN); Surya Prakash Mishra, Bengaluru (IN)

(21) Appl. No.: 19/030,483

(22) Filed: Jan. 17, 2025

(30) Foreign Application Priority Data
Sep. 6, 2024 (IN) 202441067447

(51) Int. Cl. H02J 7/00; B60L 1/00; B60L 1/04; H02H 1/00; H02H 7/18

(52) U.S. Cl. CPC H02J 7/663; H02H 1/0007; H02H 7/18; H02J 7/56; H02J 7/62; H02J 7/68; H02J 7/855; B60L 1/003; B60L 1/04; H02J 2105/30

(57) ABSTRACT

An example system includes a first battery; a second battery; a switch coupled to the first battery and the second battery, the switch configured to, based on a control signal, connect or disconnect at least one of the first battery from a load or the second battery from a load; and a current sensor to generate the control signal, the current sensor including a first sensor input terminal and a second sensor input terminal; and an amplifier configured to operate as an amplifier to determine an amount of current between the first sensor input terminal and the second sensor input terminal; and operate as a comparator to determine a direction of the current between the first sensor input terminal and the second sensor input terminal, the control signal corresponding to at least one of the amount of current or the direction of the current.

### CROSS-REFERENCE TO RELATED APPLICATION

This patent application claims the benefit of and priority to Indian Provisional Patent Application No. 202441067447 filed Sep. 6, 2024, which is hereby incorporated herein by reference in its entirety.

### TECHNICAL FIELD

This description relates generally to circuitry, and, more particularly, to methods and apparatus to implement current sensors.

### BACKGROUND

Current sensors determine the amount or direction of current within a circuit. For example, a current sensor can detect electrical current in a wire, etch, path, etc. and generate a signal proportional to the current. In this manner, another device can access the signal to determine the current. Current sensors can be used to provide data to a processing device, a user, or to trigger an action. For example, current sensors can be used to control switches to provide protection to one or more portions of a circuit when the current is too high or when the current is flowing in an opposite direction than intended.

### SUMMARY

For implementing a current sensor, an example apparatus includes a first sensor input terminal and a second sensor input terminal; a first multiplexer including a first input terminal, a second input terminal, a select terminal, and an output terminal, the first input terminal of the first multiplexer coupled to the first sensor input terminal, the second input terminal of the first multiplexer coupled to the second sensor input terminal; a second multiplexer including a first input terminal, a second input terminal, a select terminal, and an output terminal, the first input terminal of the second multiplexer coupled to the second input terminal of the first multiplexer, the second input terminal of the second multiplexer coupled to the first input terminal of the first multiplexer; an amplifier including a first stage and a transistor, the first stage including a first input terminal, a second input terminal, and an output terminal, the first input terminal of the first stage coupled to the output terminal of the first multiplexer, the second input terminal of the first stage coupled to the output terminal of the second multiplexer, the transistor including a first current terminal, a second current terminal, and a control terminal, the control terminal of the transistor coupled to the output terminal of the first stage; and polarity detection circuitry including an input terminal and an output terminal, the input terminal of the polarity detection circuitry coupled to the first current terminal of the transistor, the output terminal of the polarity detection circuitry coupled to at least one of the select terminal of the first multiplexer or the select terminal of the second multiplexer. Other examples are described.

For implementing a current sensor, an example apparatus includes a first input terminal, a second input terminal, and an output terminal; an amplifier including a first input terminal and a second input terminal; a multiplexer configured to: connect the first input terminal to the first input terminal of the amplifier based on a polarity signal being a first voltage, the polarity signal corresponding to a direction of a first current; and connect the second input terminal to the first input terminal of the amplifier based on the polarity signal being a second voltage; and the amplifier configured to: based on (a) the first current between the first input terminal and the second input terminal flowing in a first direction and (b) the multiplexer connection the first input terminal to the first input terminal of the amplifier, operate as an amplifier to cause sinking of a second current through the output terminal; and after the first current changes to a second direction opposite the first direction, operate as a comparator to cause the polarity signal to change to the second voltage. Other examples are described.

For implementing a current sensor, an example system includes a first battery configured to provide first power to a load; a second battery configured to provide second power to the load; a switch coupled to the first battery and the second battery, the switch configured to, based on a control signal, connect or disconnect at least one of the first battery from the load or the second battery from the load; and a current sensor to generate the control signal, the current sensor including: a first sensor input terminal and a second sensor input terminal; and an amplifier configured to: operate as an amplifier to determine an amount of current between the first sensor input terminal and the second sensor input terminal; and operate as a comparator to determine a direction of the current between the first sensor input terminal and the second sensor input terminal, the control signal corresponding to at least one of the amount of current or the direction of the current. Other examples are described.

### BRIEF DESCRIPTION OF THE DRAWINGS

FIG. 1 is an example system diagram to provide power to a load.

FIG. 2 is an example circuit implementation of a current sensor of FIG. 1.

FIG. 3A is an alternative example circuit implementation of a current sensor of FIG. 1.

FIG. 3B is an alternative circuit implementation of the current sensor of FIG. 3A.

FIG. 4 is an example circuit implementation of the polarity control circuitry of FIG. 3A.

FIG. 5 is an alternative example circuit implementation of a current sensor of FIG. 1.

FIG. 6 is an alternative example circuit implementation of a current sensor of FIG. 1.

FIG. 7 is a state diagram that may be used to implement the polarity control circuitry of FIG. 6.

FIG. 8 is an example timing diagram illustrating issues related to a current sensor.

FIG. 9 is an example timing diagram associated with a current sensor corresponding to examples described herein.

The same reference numbers or other reference designators are used in the drawings to designate the same or similar (functionally or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines or boundaries may be idealized. In reality, the boundaries or lines may be unobservable, blended or irregular.

Vehicles, such as hybrid or electric vehicles, utilize many power supplies (e.g., batteries) to provide power to a load. In some systems, switching circuitry can be used to disconnect a load from a power supply. In some examples, reverse current in a system can be used to charge one or more batteries. Such systems rely on current sensing to allow a controller in the vehicle to be aware of the direction of current and the amount of current at various points in the system. In some examples, current sensing can be used to control the switching circuitry to protect one or more components in a system from obtaining high current or reverse current. Because the current in a system can change quickly (e.g., increasing, decreasing, reversing direction), bi-directional glitch-free current sensors with fast response time are desirable. Also, current sensing can be used in any power path application where current sensing is desired from input to output or from output to input.

Examples described herein provide one or more bidirectional current sensors with one amplifier that operates as an amplifier and a comparator to determine an amount of current and a direction of the current (also referred to as the polarity of the current). The amplifier automatically adjusts operation from an amplifier to a comparator when the current changes direction. When operating as a comparator, the output of the comparator is used to select the inputs of one or more multiplexers to adjust the connections of the amplifier to return to operation as an amplifier. Examples described herein result in a highly accurate current sense with minimal components, area, or complexity and a full range to generate an output signal that can be used to determine the amount of current that the current sensor sensed. Also, examples described herein result in less or no oscillations when transitioning from a first current polarity to a second current polarity.

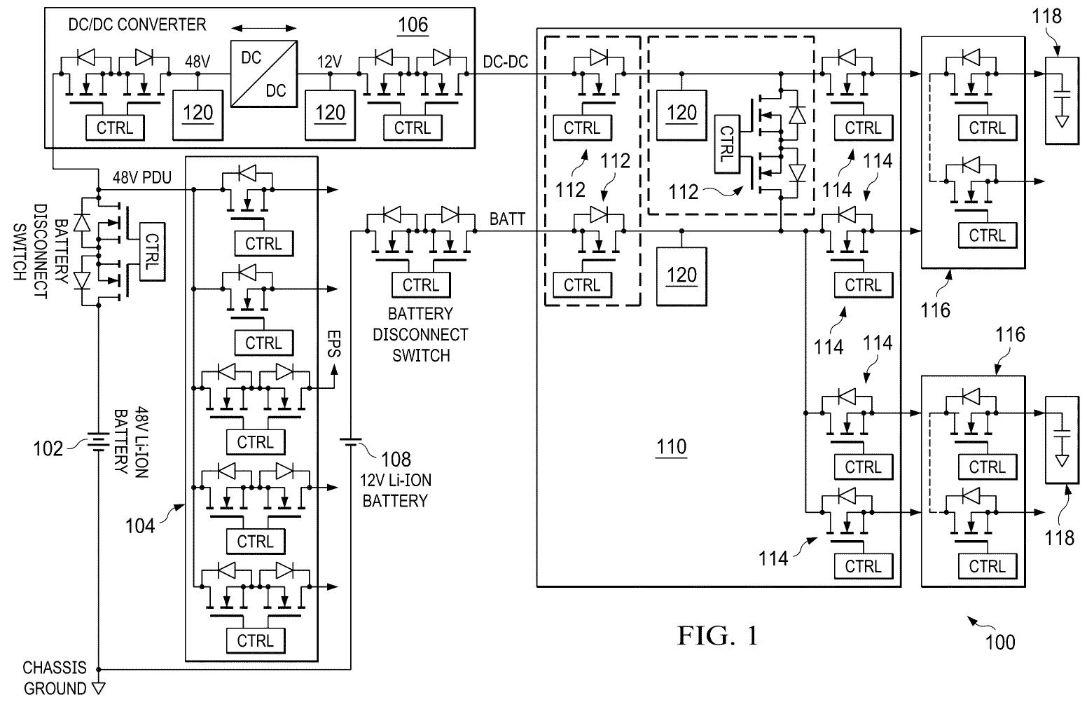

FIG. 1 illustrates an example system 100 for power components of a vehicle (e.g., an electric vehicle, a hybrid vehicle, etc.). The system 100 includes example power sources 102, 108, example power distribution circuitry 104, example power converter circuitry 106, an example power distribution unit (PDU) 110, example switches 112, 114, example zonal controllers 116, example loads 118, and example current sensors 120.

The power source 102 of FIG. 1 is a first voltage (e.g., 48 Volts(V)) battery that can be used to power one or more components in a system. For example, the power source 102 may power the electric fans, electric water pumps, air compressors, power steering, heating systems, compressors, etc. The power source 102 is coupled to ground. The power source 102 is also coupled to the power distribution circuitry 104 and the power converter circuitry 106 via a battery disconnect switch. The battery disconnect switch may decouple the power source 102 from the power distribution circuitry 104 and the power converter circuitry 106 in the event of an error.

The power distribution circuitry 104 of FIG. 1 is coupled to the power source 102 to provide power from the power source 102 to one or more systems of the vehicle. For example, the power distribution system includes switches that can couple or decouple the power source 102 to one or more of an electric fan, an electric water pump, an air compressor, power steering, a heating system, a compressor, etc.

The power converter circuitry 106 of FIG. 1 includes a power converter, disconnect switches, and the current sensors 120. The power converter of the power converter circuitry 106 converts the voltage of the power source 102 to a second smaller voltage. For example, the power converter circuitry 106 may be a direct current (DC)-to-DC converter that converts a first voltage (48 V) of the power source 102 to a second voltage (e.g., 12 V). The disconnect switches disconnect or connect the power converter from/to the first power source 102 or to from the PDU 110. The current sensors 120 determine the amount of current and the direction of the current, as further described below.

The power source 108 of FIG. 1 is a second voltage (e.g., 12 V) battery that can be used to power one or more components in a system. For example, the power source 108 may power the radio, the infotainment, the headlights, window regulators, etc. The power source 108 is coupled to ground. The power source 108 is also coupled to PDU 110 via a battery disconnect switch. The battery disconnect switch may decouple the power source 108 from PDU 110 in the event of an error.

The PDU 110 of FIG. 1 distributes power from the power converter circuitry 106 or the power source 108 to the loads 118 (e.g., directly or via the zonal controller 116). Also, the PDU 110 may use reverse current (e.g., current toward the power source 108) to charge the power source 108. The PDU 110 includes protection switches 112 to connect or disconnect the one or more of the power converter circuitry 106 or the power source 108 to/from each other or one or more loads. The PDU 110 further includes switches 114 to provide the power from one or more of the power converter circuitry 106 or the power source 108 to the one or more loads. The PDU 110 further include the current sensors 120 to determine the amount or direction of current within the PDU 110, as further described below. The PDU 110 is coupled to the power converter circuitry 106, the power source 108 (e.g., via a disconnect switch), loads (e.g., actuators) or zonal controllers 116. The zonal controllers 116 are nodes in the system 100 that operate as a hub for power distribution to the corresponding load 118. The zonal controllers 116 are coupled to the PDU 110 and the corresponding loads 118 or actuators.

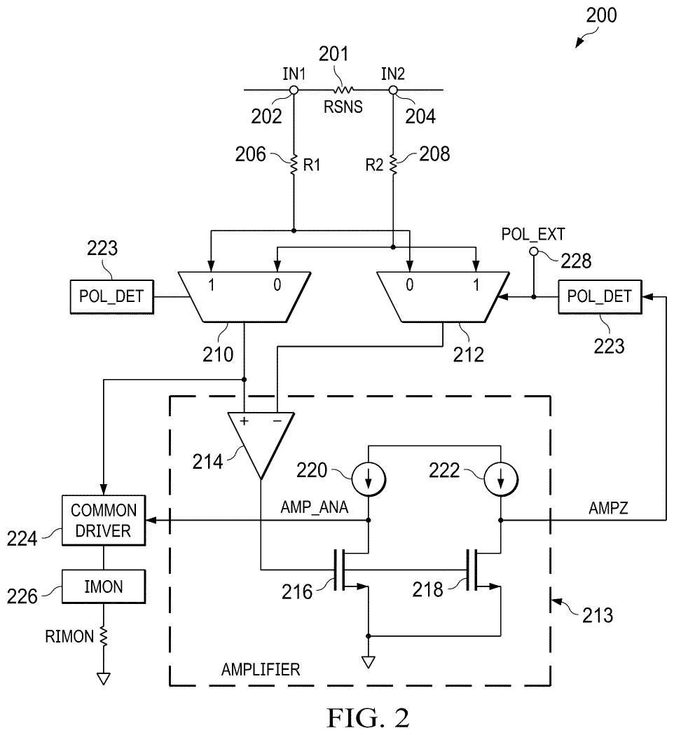

The current sensors 120 of FIG. 1 are bidirectional current sensors. The current sensors 120 generate a first output signal that corresponds to the amount of a current being sensed and a second output signal that corresponds to the direction or polarity of the current being sensed. The amount of current or the direction of current can be used to control any one or more of the switches in the system 100. Also, the amount of current or direction of the current can be sent to a processor or any other component of a vehicle or other system. Although the current sensors 120 are located at particular locations within the system 100, a current sensor could be implemented at any part of the system 100. As further described below, the current sensors 120 implement a single amplifier and other circuitry to cause the amplifier to operate as both an amplifier and a comparator and switch operation based on a change in current direction/polarity. Example implementations of one of the current sensors 120 are further described below in conjunction with FIGS. 2-6.

FIG. 2 is an example bidirectional current sensor 200. The bidirectional current sensor 200 is an example circuit implementation of one of the current sensors 120 of FIG. 1. FIG. 2 includes a sense resistor 201 and the bidirectional current sensor 200. The bidirectional current sensor 200 includes example sensor input terminals 202, 204, example resistors 206, 208, example multiplexers 210, 212, an example amplifier 213, the amplifier 213 including an example first stage 214, example transistors 216, 218, and example current sources 220, 222, an example driver 224, and example sensor output terminals 226, 228.

The resistor 201 of FIG. 2 is a sense resistor that the bidirectional current sensor 200 uses to create a voltage differential or sink current from one of the input terminals 202, 204 toward the output terminal 226. The voltage drop across the resistor 201 corresponds to the current being sensed by the bidirectional amplifier 213. The resistor 201 has a first terminal coupled to the first sensor input terminal 202 and a second terminal coupled to the second sensor input terminal 204.

The resistors 206, 208 of FIG. 2 are input resistors that can provide a path for current to travel toward the output terminal 226. The resistor 206 includes a first terminal coupled to the first sensor input terminal 202 and a second terminal coupled to the second input terminal of the first multiplexer 210 and the first input terminal of the second multiplexer 212. The resistor 208 includes a first terminal coupled to the second sensor input terminal 204 and a second terminal coupled to the first input of the first multiplexer 210 and the second input of the second multiplexer 212.

The multiplexer 210 of FIG. 2 is configured to couple the first input terminal of the multiplexer 210 to the output terminal of the multiplexer 210 or the second input terminal of the multiplexer 210 to the output terminal of the multiplexer 210 based on the voltage at the select terminal of the multiplexer 210. For example, if the voltage at the select terminal of the multiplexer 210 is a logic low voltage, the multiplexer 210 couples the second terminal of the resistor 208 to the non-inverting input terminal of the first stage 214 and a first input of the driver circuitry 224. If the voltage at the select terminal of the multiplexer 210 is a logic high voltage, the multiplexer 210 couples the second terminal of the resistor 206 to the non-inverting input terminal of the first stage 214 and the first input terminal of the driver circuitry 224. The first input terminal of the multiplexer 210 is coupled to the second terminal of the resistor 208 and the second input terminal of the multiplexer 212. The second terminal of the multiplexer 210 is coupled to the second terminal of the resistor 206 and the first terminal of the multiplexer 212. The select terminal of the multiplexer 210 is coupled to the polarity detection circuitries 223 and the polarity output terminal 228. The output terminal of the multiplexer 210 is coupled to a first input terminal (e.g., the non-inverting input terminal) of the first stage 214 and the first input terminal of the driver 224.

The multiplexer 212 of FIG. 2 is configured to couple the first input terminal of the multiplexer 212 to the output terminal of the multiplexer 212 or the second input terminal of the multiplexer 212 to the output terminal of the multiplexer 212 based on the voltage at the select terminal of the multiplexer 212. For example, if the voltage at the select terminal of the multiplexer 212 is a logic low voltage, the multiplexer 212 couples the second terminal of the resistor 208 to the inverting input terminal of the first stage 214. If the voltage at the select terminal of the multiplexer 212 is a logic high voltage, the multiplexer 212 couples the second terminal of the resistor 206 to the inverting input terminal of the first stage 214. The first input terminal of the multiplexer 212 is coupled to the second terminal of the resistor 206 and the second input terminal of the multiplexer 210. The second terminal of the multiplexer 212 is coupled to the second terminal of the resistor 208 and the first terminal of the multiplexer 210. The select terminal of the multiplexer 212 is coupled to the polarity detection circuitries 223 and the polarity output terminal 228. The output terminal of the multiplexer 212 is coupled to a second input terminal (e.g., the inverting input terminal) of the first stage 214.

The amplifier 213 includes the first stage 214 to compare the voltage at the two input terminals. The amplifier 213 further includes a second stage corresponding to the transistor 216 and the current source 220. The amplifier 213 further includes a third stage corresponding to the transistor 218 and the current source 222. The second stage is amplifying circuitry to generate an analog signal at the AMP_ANA node/terminal to drive the driver 224. The analog signal at the AMP_ANA node/terminal corresponds to a difference between the voltages at the input terminals of the first stage 214. The third stage is comparator circuitry to generate a digital signal at the AMPZ node/terminal which is applied to the polarity detection circuitries 223. The digital signal at the AMPZ node/terminal corresponds to whether the amplifier 213 is operating in regulation or out of regulation.

When the current to/from the sensor input terminals 202, 204 is in a first direction, the amplifier 213 regulates a loop to provide a scaled version of a difference between the voltages at the first input terminal (e.g., the non-inverting input terminal) and the second input terminal (e.g., the inverting input terminal), and the regulated loop is configured to adjust the voltages at the two input terminals to have the same value. The first stage 214 outputs the amplified difference to control the transistors 216, 218. Because the output of the amplifier drives the transistor 216 and the first current terminal of the transistor 216 drives the driver 224, the transistor 216 and the driver 224 create a feedback loop, thereby causing the first stage 214 to amplify the difference between the voltage at the two input terminals, the first stage 214 configured to adjust the voltage at the input terminals to be equal. As further described below, the driver 224 draws (e.g., sinks) current from one of the resistors 206, 208 toward an output resistor via the output terminal 226 in the attempt to make the input voltages of the first stage 214 equal.

After the current to/from the sensor input terminals 202, 204 switches direction (e.g., two a second direction different than the first direction), the amplifier 213 can no longer regulate the voltages at the input terminals 202, 204 because the driver 224 is attempting to draw current from the wrong resistor 206, 208. Accordingly, after the current direction changes, the amplifier 213 goes out of regulation, thereby causing the amplifier 213 to operate as a comparator. When the amplifier 213 operates as a comparator, the first stage 214 outputs a logic high voltage when the voltage at the first input terminal is higher than the voltage at the second input terminal and outputs a logic low voltage when the voltage at the first terminal is lower than the voltage at the second input terminal. As further described below, the digital output of the first stage 214 when operating as a comparator is used to drive the transistor 218, thereby causing the polarity detection circuitries 223 to flip the voltage at the select terminal of the MUXs 210, 212 and the voltage at the polarity output terminal 228 (e.g., from a logic high to a logic low or a logic low to a logic high). Flipping the voltage at the MUXs 210, 212 causes the MUXs 210 to switch the connections between the resistors 206, 208 and the input terminals of the first stage 214, thereby causing the amplifier 213 to return back to regulation and operate as an amplifier to sink current from the appropriate resistor 206, 208 toward the output terminal 226 and attempt to cause the voltage at the input terminals to be equal. Accordingly, every time the current between the sensor input terminals 202, 204 changes directions, the amplifier 213 operate as a comparator causing the polarity signal applied to the select terminals of the multiplexers 210, 212 to flip, thereby causing the amplifier 213 to return to operation from a comparator to an amplifier based on the new current polarity. The amplifier 213 causes the voltage or current at the output terminal 226 to correspond to an amount of current between the sensor input terminals 202, 204 and causes the voltage at the polarity output terminal 228 to correspond to a polarity of the current between the sensor input terminals 202, 204. Accordingly, the amplifier 213 can be configured to control one or more of the switches 112 of FIG. 1 based on the amount or polarity of sensed current.

The first input terminal (e.g., the non-inverting input terminal) of the first stage 214 is coupled to the output of the multiplexer 210 and the first input of the driver 224. The second input terminal (e.g., the inverting input terminal) of the first stage 214 is coupled to the output terminal of the multiplexer 212. The output terminal of the first stage 214 is coupled to the control terminals of the transistors 216, 218.

The transistors 216, 218 of FIG. 2 each control how much current can flow between the two current terminals of the respective transistors 216, 218 based on an amount of voltage applied to the control terminal of the respective transistors 216, 218. For example, when the voltage output by the first stage 214 is low (e.g., below a threshold voltage of the transistors 216, 218), no current flows from the first current terminal of the transistor 216 to the second current terminal of the transistor 216 and no current flows from the first current terminal of the transistor 218 and the second current terminal of the transistor 218. When the voltage output by the first stage 214 is above the threshold voltage but below a saturation threshold, the amount of current that the transistors 216, 218 allow to flow from the first current terminal to the second current terminal is a function of the voltage output by the first stage 214 (e.g., the higher the voltage the higher the amount of current). When the voltage output by the first stage 214 is above the saturation threshold, the transistors 216, 218 allow all current from the first current terminal to flow toward the second current terminal. The control terminal (e.g., gate terminal) of the transistor 216 is coupled to the output terminal of the first stage 214. Also, the resistance between the two current terminals of each of the transistors 216, 218 decreases as the voltage at the gate increases. Accordingly, the higher the voltage output by the first stage 214, the lower the gain, which corresponds to a higher voltage at the first current terminal of the corresponding transistors 216, 218. However, if the transistors 216, 218 are implemented by p-channel devices, the higher the voltage output by the first stage 214, the higher the gain, which corresponds to a lower voltage at the first current terminal of the p-channel devices. The control terminals (e.g., gate terminals) of the transistors 216, 218 are coupled to the output terminal of the first stage 214 and to each other. The first current terminal (e.g., the drain terminal) of the transistor 216 is coupled to a second input terminal of the driver 224 and second terminal of the current source 220 via the analog amplifier (AMP_ANA) node. The first current terminal of the transistor 218 is coupled the polarity detection circuitries 223 via the AMPZ node. The second current terminal (e.g., the source terminal) of the transistor 216 is coupled to ground. The second current terminal of the transistor 218 is coupled to ground.

When the amplifier 213 operates as an amplifier, the difference between the voltages at the two inputs of the first stage 214 are gained an output by the first stage 214 to the control terminals of the transistor 216. Because the gain of the transistors 216 is a function of the voltage at the control terminals of the transistors 216 and inverted in phase, the higher the voltage output by the first stage 214, the lower the drain voltage due to the gain of the transistors 216, thereby resulting in a lower voltage at the second input of the driver 224. As further described below, decreasing the voltage at the second input of the driver 224 can cause the driver 224 to increase the amount of current that is drawn toward the sensor output terminal 226 (e.g., depending on whether the driver 224 is implemented with a p-channel device or the inverse is true for an n-channel device with a different driver). The transistor 216 uses the output signal from the first stage 214 to drive the driver 224 to draw current from the positive terminal of the first stage 214 such that the voltage at both input terminals of the first stage 214 are the same.

After the polarity flips, the amplifier 213 operates as a comparator. When the amplifier 213 operates as a comparator, the digital output of the first stage 214 causes the transistor 218 to operate as a switch (e.g., the output voltage of the first stage 214 causing the transistor 218 to operate as an open circuit or a closed circuit based on the output of the first stage 214). For example, if the first stage 214 outputs a logic high voltage, the transistor 218 operates as closed switches to create a short to ground. Thus, the voltage at the polarity detection circuitries 223 corresponds to a logic low voltage. If the first stage 214 outputs a logic low voltage, the transistor 218 operates as open switches to block the connection to ground. Thus, the voltage at the polarity detection circuitries 223 is a logic high voltage.

Although the transistor 216 of FIG. 2 is an n-channel metal oxide semiconductor (NMOS) field effect transistor (FET), the transistor 216 could be replaced with a different type transistor or other amplifying circuitry. Also, although the transistor 218 is an NMOS, the transistor 218 could be replaced with a different type or transistor or comparator circuitry.

The current sources 220, 222 of FIG. 2 pump current toward the first current terminals of the corresponding transistors 216, 218. The first terminal of the current source 220 is coupled a voltage supply (e.g., VDD). The first terminal of the current source 222 is coupled to the voltage supply. The second terminal of the current source 220 is coupled to the driver 224 and the first current terminal of the transistor 216. The second terminal of the current source 222 is coupled to the first current terminal of the transistor 218, the polarity output terminal 228, and the select terminals of the multiplexers 210, 212. The amount of current supplied by the current sources 220, 222 are different. For example, the amount of current supplied by the current source 220 may be less than the amount of current supplied by the current source 222. The amount of current supplied by the current source 220 ensures that the transistor 216 operates as an analog amplifier and the amount of current supplied by the current source 222 ensures that the transistor 218 operates as a digital comparator.

The polarity detection circuitries 223 of FIG. 2 obtains the AMPZ signal and outputs a control signal based on the AMPZ signal. For example, as described above, the AMPZ signal switches when the amplifier 213 is out of regulation. The polarity detection circuitries 223 detects the transition and latches between a high voltage and a low voltage for each transition. Thus, the output of the polarity detection circuitries 223 corresponds to the direction or polarity of the current being sensed. The polarity detection circuitries 223 may include one or more logic gates (e.g., NOT gates), edge detection circuitry, digital latches, or state machines to convert the AMPZ signal into the polarity signal. The polarity detection circuitries 223 each include an input terminal coupled to the first current terminal of the transistor 218 and the current source 222 via the AMPZ terminal. The polarity detection circuitries 223 each include an output terminal coupled to a corresponding select terminal of the multiplexers 210, 212. In some examples, the polarity detection circuitries 223 is implemented by a single polarity detection circuitry that outputs the polarity detection signal to both select terminals of the multiplexers 210, 212.

The driver 224 of FIG. 2 may be a p-type device or an n-type device that draws or sinks current from the output of the multiplexer 210 toward the output terminal of the multiplexer 210 based on the voltage at the second input terminal of the driver 224. For example, when the voltage of the second input terminal of the driver 224 is low and the driver 224 is a n-type device, the driver 224 sinks less current than when the voltage at the second input terminal of the driver 224 is high. When the voltage of the second input terminal of the driver 224 is low and the driver 224 is a p-type device, the driver 224 sinks more current than when the voltage at the second input terminal of the driver 224 is high. The first input terminal of the driver 224 is coupled to the output terminal of the multiplexer 210 and the first input terminal of the first stage 214. The second input terminal of the driver 224 is coupled to the first current terminal of the transistor 216 and the second terminal of the current source 220. The output terminal of the driver 224 is coupled to the sensor output terminal 226.

In the example of FIG. 2, the signal or voltage (e.g., the polarity signal, the polarity detection signal, the current direction signal, the current direction detection signal, etc.) at the polarity output terminal 228 corresponds to the polarity of the current across the sense resistor 201. In FIG. 2, the polarity signal is output to the polarity output terminal 228 and the select terminals of the multiplexers 210, 212. However, as further described below, the polarity signal can be split into two different signals (e.g., an internal polarity signal and an external polarity signal).

Although FIG. 2 provides a full-scale bidirectional current sensor (e.g., a sensor that can measure both positive and negative values of a physical quantity across its entire measurement range) with fewer components and without component mismatch issues, the bidirectional current sensor 200 of FIG. 2 can suffer from blind zone issues. A blind zone is an area where the amplifier is not able to regulate, even when the current is in the same direction as the amplifier has been configured to regulate. Although an ideal amplifier would go out of regulation at input flip, in practice, amplifiers, such as amplifier 213, have some amount of offset. The offset of the amplifier 213 creates the blind zone. Accordingly, if the amplifier 213 is operating as an amplifier for current in a first direction and the current decreases to within the blind zone, but does not changer polarity, the amplifier 213 may go out of regulation to operate as a comparator prematurely. If the current then increases without switching direction, the 213 continues to operate as a comparator but is stuck with the inputs connected incorrectly and will not be able to return to amplifier operation. As described below, the bidirectional current sensor 200 of FIG. 2 can be adjusted to solve problems associated with the blind zone using time polling when the amplifier 213 is operating within the blind zone.

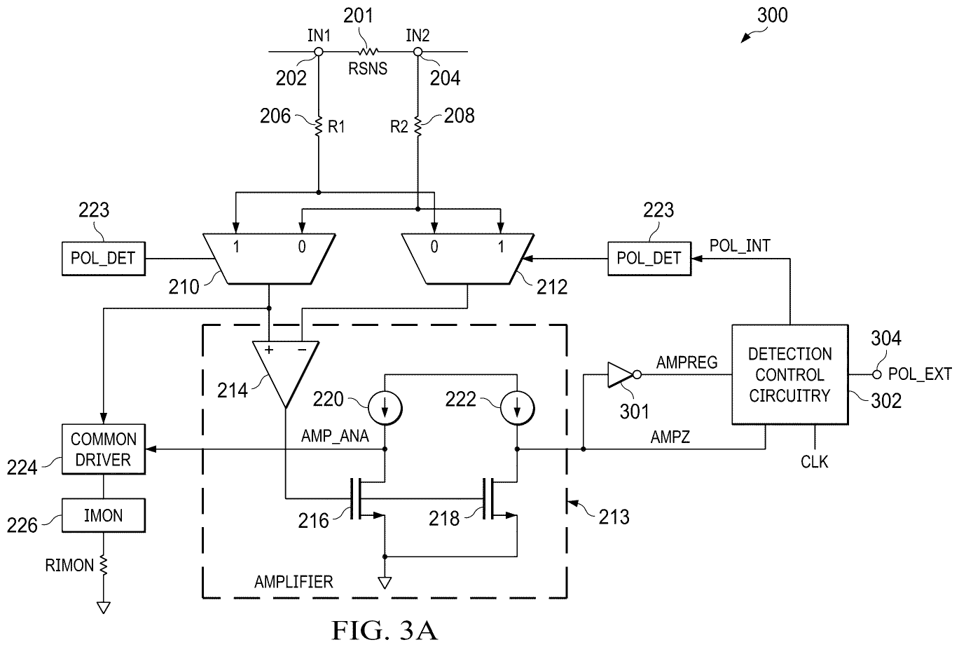

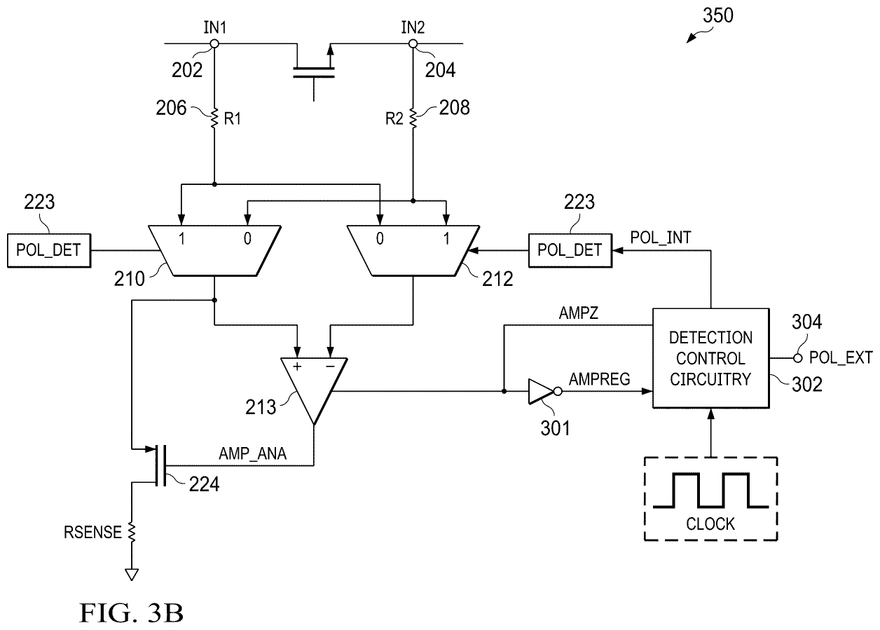

FIG. 3A is an example bidirectional current sensor 300. The bidirectional current sensor 300 is an example circuit implementation of one of the current sensors 120 of FIG. 1 that uses time polling within a bind zone. FIG. 3A includes the sense resistor 201, the example sensor input terminals 202, 204, the example resistors 206, 208, the example multiplexers 210, 212, the example amplifier 213, the example first stage 214, the example transistors 216, 218, the example current sources 220, 222, the example driver 224, and the example sensor output terminal 228 of FIG. 2. FIG. 3A further includes an example logic gate 301, example polarity detection control circuitry 302, and an example sensor polarity output terminal 304.

The logic gate 301 of FIG. 3 is a logic NOT gate that generates an output signal by inverting the input signal. For example, if the input signal is a logic low voltage, the logic gate 301 outputs a logic high voltage and vice versa. The logic gate 301 generates the amplifier regulation (AMPREG) signal as an inverted signal to the AMPZ signal. Accordingly, when the AMPZ signal is low, the APZ signal is high and vice versa. AMPREG signal corresponds to when the amplifier 213 is operating in regulation or out of regulation. In some examples, the logic gate 301 may be implemented in the amplifier 213 or in the polarity detection control circuitry 302. The input of the logic gate 301 is coupled to the first current source of the transistor 218 and the second terminal of the current source 222. The output of the logic gate 301 is coupled to the polarity detection control circuitry 302.

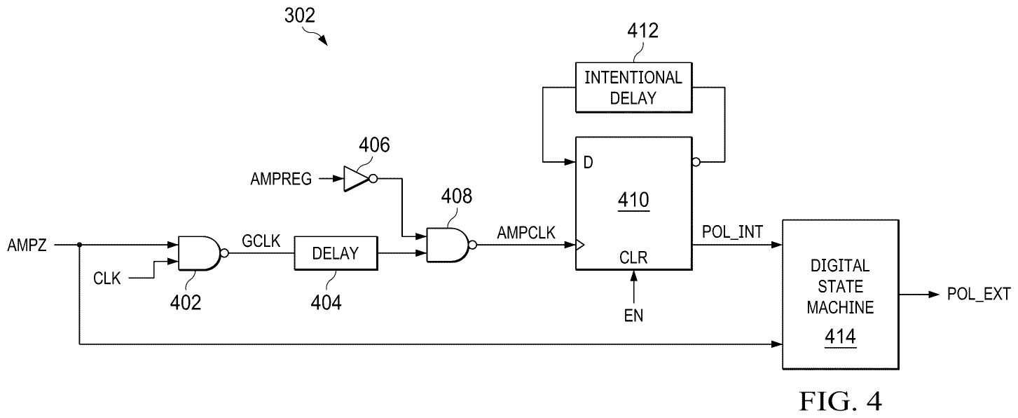

The polarity detection control circuitry 302 of FIG. 3A determines when the current between the sensor input terminals 202, 204 (e.g., the sensed current) is within the blind zone and automatically toggles between polarities (e.g., switching between logic high and logic low) until the current between the sensor input terminals 202, 204 is outside of the blind zone. Accordingly, because the polarity detection control circuitry 302 toggles the polarity, the amplifier 213 does not get stuck out operating out of regulation when the sensed current drops to the blind zone and then increases outside of the blind zone without switching direction. The polarity detection control circuitry 302 uses one or more of the voltages at the AMPREG terminal or the AMPZ terminal to determine when amplifier 213 is operating within the blind zone (e.g., after the operation switches from amplifier to comparator or goes out of regulation). The polarity detection control circuitry 302 uses a clock signal to generate the toggling of the polarity and outputs the polarity signal to the polarity detection circuitries 223. The period of the clock signal may be greater than the settling time of the amplifier 213. Because the polarity detection control circuitry 302 toggles the polarity artificially when in the blind zone, in FIG. 3A, the polarity output terminal 228 is separate from the POLINT signal that the polarity detection circuitries 223 use to control the select terminals of the multiplexers 210, 212. In this manner, when the polarity detection control circuitry 302 is artificially toggling polarity while in the blind zone, the end user does not see the toggling. The first input of the polarity detection control circuitry 302 is coupled to the output of the logic gate 301. The second input of the polarity detection control circuitry 302 is coupled to the first current terminal of the transistor 218 and the second terminal of the current source 222. The third input terminal of the polarity detection control circuitry 302 is coupled to a clock generated (e.g., located within or outside of the bidirectional sensor 300). The first output terminal of the polarity detection control circuitry 302 is coupled to the polarity detection circuitries 223. The second output terminal of the polarity detection control circuitry 302 is coupled to the sensor polarity output terminal 304. The polarity detection control circuitry 302 may be implemented by any combination of software, hardware, or firmware. In some examples, the polarity detection control circuitry 302 is implemented by a state machine. An example hardware implementation of the polarity detection control circuitry 302 is further described below in conjunction with FIG. 4.

FIG. 3B illustrates example bidirectional current sensors 350 that is an alternative implementation of the bidirectional current sensor 300 of FIG. 3A. The polarity detection control circuitry 350 includes the sensor input terminals 202, 204, the multiplexers 210, 212, the resistors 206, 208, the multiplexers 210, 212, the amplifier 213, the polarity detection circuitries 223, the driver 224, the logic gate 301, the polarity detection control circuitry 302 and the sensor polarity output terminal 304 of FIG. 3A. As described above, the example logic gate 301 may be implemented in the amplifier 213 or the polarity detection control circuitry 302. Also, in the example of FIG. 3B, the driver 224 is implemented by a p-channel MOSFET. However, the driver 224 may be implemented by any other type of transistor or driver circuitry.

FIG. 4 is an example hardware implementation of the polarity detection control circuitry 302 of FIG. 3A. The polarity detection control circuitry 302 includes example logic gates 402, 406, 408, example delay circuitry 404, 412, an example flip flop 410, and an example state machine 414.

The logic gate 402 of FIG. 4 is a not and (NAND) gate that outputs a logic high voltage when the voltage at both terminals of the logic gate 402 are logic low voltage and outputs a logic low voltage if either one, or both voltages at the input terminals of the logic gate 402 is/are a logic high voltage. Accordingly, when (a) the voltage at the AMPZ terminal of FIG. 3A and (b) the clock signal are both a logic low voltage, the logic gate 402 outputs a logic high voltage. Otherwise, the logic gate 402 outputs a logic low voltage. If the amplifier 213 is out of regulation, the AMPZ signal is a logic low. Accordingly, when the clock signal goes low and the amplifier 213 is out of regulation, the logic gate 402 outputs a logic high voltage. However, if (a) the amplifier 213 is in regulation or (b)(i) the amplifier 213 is out of regulation and (ii) the clock signal is low, the logic gate 402 outputs a logic low voltage. The first input terminal of the logic gate 402 is coupled to the first current terminal of the transistor 218 and the second current source 222. The second input terminal of the logic gate 402 is coupled to clock signal generation circuitry. The output terminal of the logic gate 402 is coupled to the delay circuitry 404.

The delay circuitry 404 of FIG. 4 is circuitry that outputs a signal that is a delayed version of the input signal. For example, if the output of the logic gate 402 adjusts from a logic high to a logic low, the delay circuitry 404 adjusts the output signal from a logic high to a logic low after a duration of time. The input terminal of the delay circuitry 404 is coupled to the output terminal of the logic gate 402. The output terminal of the delay circuitry 404 is coupled to the second input terminal of the logic gate 408.

The logic gate 406 is a NOT gate or an inverter. The logic gate 406 inverts the AMPREG voltage from the first current terminal of the transistor 216 of FIG. 3A. For example, if the AMPREG voltage is a logic high voltage, the logic gate 406 outputs a logic low voltage and, if the AMPREG voltage is a logic low voltage, the logic gate 406 outputs a logic high voltage. The input terminal of the logic gate 406 is coupled to the first current terminal of the transistor 216, the second terminal of the current source 220, and the second input of the driver 224. The output terminal of the logic gate 406 is coupled to the first input terminal of the logic gate 408.

The logic gate 408 of FIG. 4 is a NAND gate that outputs a logic high voltage when the voltage at both terminals of the logic gate 408 are logic low voltage and outputs a logic low voltage if either one, or both voltages at the input terminals of the logic gate 408 is/are a logic high voltage. Accordingly, when (a) the voltage at the output of the logic gate 408 of FIG. 3A and (b) the voltage at the output of the delay circuitry 404 are both a logic low voltage, the logic gate 408 outputs a logic high voltage. Otherwise, the logic gate 408 outputs a logic low voltage. If the amplifier 213 goes out of regulation, the AMP signal goes to a logic low, causing the first input of the logic gate 408 to increase to a logic high voltage. Also, when the amplifier 213 goes out of regulation, the voltage at the second input terminal is also a logic low voltage. Accordingly, the output of the logic gate 408 adjusts to a logic high voltage. Thus, during the initial change of the amplifier 213 from amplifier to comparator (e.g., in regulation to out of regulation), the logic gate 408 triggers the flip flop 410 using the initial rising edge caused by the voltage at the AMP terminal. After the initial change, the logic gate 408 controls the flip flop based on the clock signal until the amplifier 213 returns to being in regulation. The first input terminal of the logic gate 408 is coupled to the output terminal of the logic gate 406. The second input terminal of the logic gate 408 is coupled to the output terminal of the delay circuitry 404. The output terminal of the logic gate 408 is coupled to the clock input terminal of the flip flop 410.

The flip flop 410 of FIG. 4, when the amplifier 213 is out of regulation, toggles the polarity between a first logic voltage corresponding to a first polarity to a second logic voltage corresponding to a second polarity. When the amplifier 213 is in regulation, the flip flop 410 outputs the polarity that results in the amplifier 213 operating in regulation. For example, when the amplifier 213 is in regulation, the AMP signal goes high. Thus, the output of the logic gate 408 remains low and the flip flop no longer toggles between the first logic voltage and the second logic voltage. For every clock pulse at the clock input terminal of the flip flop 410, the first output terminal (e.g., the inverted output terminal) outputs the opposite of the voltage at the data input terminal (D) after a delay generated by the delay circuitry 412. Thus, for each clock pulse at the clock input terminal, the output at the second output terminal (e.g., the non-inverted output terminal or Q) toggles between a logic high voltage and a logic low voltage. The clock input terminal of the flip flop 410 is coupled to the output terminal of the logic gate 408. The data input terminal of the flip flop 410 is coupled to the first inverted output terminal of the flip flop 410 via the delay circuitry 412. The second non-inverted output terminal of the flip flop 410 is coupled to polarity detection circuitries 223 of FIG. 3 and the first input of the digital state machine 414.

The delay circuitry 412 of FIG. 4 is circuitry that outputs a signal that is a delayed version of the input signal. For example, if the output of the first output terminal of the flip flop 410 adjusts from a logic high to a logic low, the delay circuitry 412 adjusts the output signal from a logic high to a logic low after a duration of time. The duration of the delay may be greater than the bandwidth of the amplifier 213 for the amplifier 213 to settle properly. The input terminal of the delay circuitry 412 is coupled to the inverted output terminal of the flip flop 410. The output terminal of the delay circuitry 412 is coupled to the data input terminal of the flip flop 410.

The digital state machine 414 of FIG. 4 maintains obtains the POLINT voltage but does not adjust the POLEXT voltage until the POLINT voltage has changed and the AMPZ signal corresponds to the amplifier 213 being in regulation. As described above, when the amplifier 213 is within the blind zone, the POLINT voltage may toggle back and forth. Accordingly, the state machine 414 discards the toggling until the amplifier 213 is back in regulation (e.g., based on the AMPZ signal) and switches the POLEXT after the POLINT signal has changed and the AMPZ signal corresponds to the amplifier 213 being in regulation. The digital state machine 414 includes a first input terminal coupled to the second output terminal of the flip flop 410, a second input terminal coupled to the AMPZ node of FIG. 3A or 3B and an output node coupled to the sensor polarity output terminal 304 of FIG. 3.

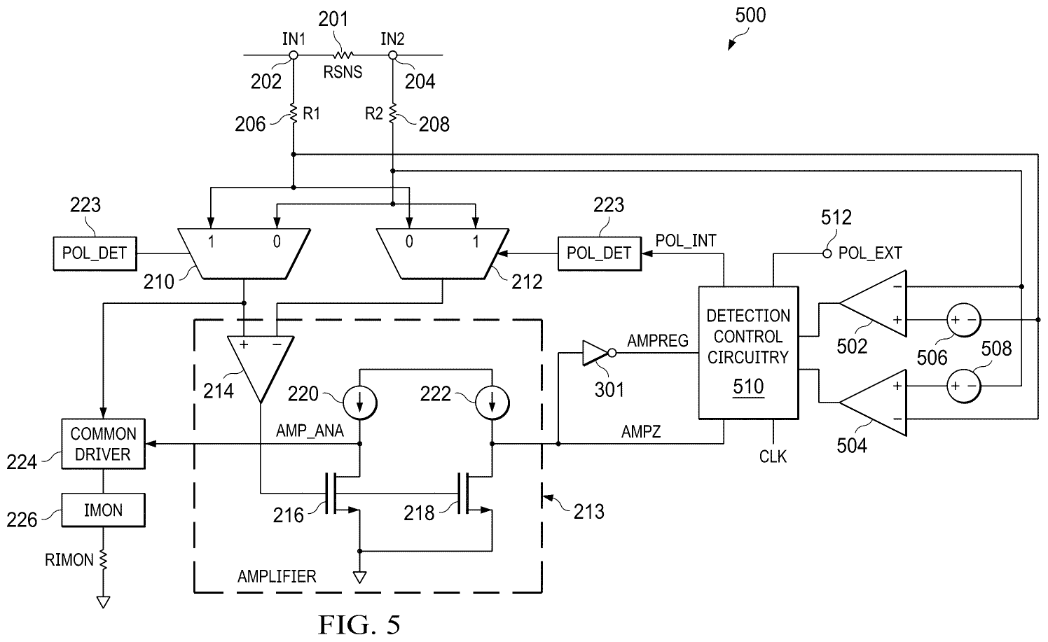

FIG. 5 is an example bidirectional current sensor 500. The bidirectional current sensor 500 is an example circuit implementation of the current sensor 120 of FIG. 1. FIG. 5 includes the sense resistor 201, the example sensor input terminals 202, 204, the example resistors 206, 208, the example multiplexers 210, 212, the example amplifier 213, the first stage 214, the example transistors 216, 218, the example current sources 220, 222, the example driver 224, the example sensor output terminal 226, and the logic gate 301 of FIGS. 2 and 3. FIG. 5 further includes example comparators 502, 504, example voltage sources 506, 508, example polarity detection control circuitry 510, and an example sensor polarity output terminal 512. The bidirectional current sensor 500 includes the comparators 502, 504 and the voltage sources 506, 508 to increase the speed of the detection of a polarity change faster than the bidirectional current sensors 200, 300, 350 of FIGS. 2, 3A, and/or 3B.

The comparator 502 of FIG. 5 is a reverse comparator that compares the voltage at a first input of the comparator 502 to the voltage at a second input of the comparator 502 and outputs a voltage based on the comparison. For example, if the voltage at the first terminal (e.g., the inverting input terminal) of the comparator 502 is lower than the voltage at the second terminal (e.g., the non-inverting input terminal) of the comparator 502, the comparator 502 outputs a logic high voltage. Otherwise, the comparator 502 outputs a logic low voltage. Because the voltage at the second terminal is adjusted by the voltage source 506, the comparator 502 determines whether the difference between the voltage at the second terminal of the resistor 206 and a sum of the voltage at the second terminal of the resistor 208 plus the voltage of the voltage supply 506 satisfies a threshold (e.g., is greater than 0 V). The amount of time that the bidirectional current sensors 200, 300, 350 determine a large current polarity change is limited by the bandwidth of the amplifier 213. In the bidirectional current sensor 500 of FIG. 5, the comparator 502 can quickly react to a large current change in an opposite direction to indicate that the polarity has changed faster than the bandwidth of the amplifier 213. The comparator 502 compares (a) the first voltage at the second terminal of the resistor 208 with (b) the sum of (i) the second voltage at the second terminal of the resistor 206 and (ii) an offset voltage generated by the voltage source 506. Accordingly, the comparator 502 detects large current changes (e.g., outside the blind zone), also referred to as large step transitions, with fast detection. The first (e.g., inverting) input of the comparator 502 is coupled to the second terminal of the resistor 208, the first input terminal of the multiplexer 210, the second input terminal of the multiplexer 212, and the first terminal of the voltage source 508. The second (e.g., non-inverting) terminal of the comparator 502 is coupled to the second terminal of the voltage source 506. The output terminal of the comparator 502 is coupled to the polarity detection control circuitry 510.

The comparator 504 of FIG. 5 is a forward comparator that compares the voltage at a first input of the comparator 504 to the voltage at a second input of the comparator 504 and outputs a voltage based on the comparison. For example, if the voltage at the first terminal (e.g., the non-inverting input terminal) of the comparator 504 is higher than the voltage at the second terminal (e.g., the inverting input terminal) of the comparator 504, the comparator 504 outputs a logic high voltage. Otherwise, the comparator 504 outputs a logic low voltage. Because the voltage at the first terminal is adjusted by the voltage source 508, the comparator 504 determines whether the difference between the voltage at the second terminal of the resistor 208 and a sum of the voltage at the second terminal of the resistor 206 plus the voltage of the voltage supply 508 satisfies a threshold (e.g., is greater than 0 V). The amount of time that the bidirectional current sensors 200, 300, 350 determine a large current polarity change is limited by the bandwidth of the amplifier 213. In the bidirectional current sensor 500 of FIG. 5, the comparator 504 can quickly react to a large current change in an opposite direction to indicate that the polarity has changed faster than the bandwidth of the amplifier 213. The comparator 504 compares (a) the sum of (i) the second voltage at the second terminal of the resistor 208 and (ii) an offset voltage generated by the voltage source 506 with (b) the first voltage at the second terminal of the resistor 206. Accordingly, the comparator 504 detects large current changes (e.g., outside the blind zone), also referred to as large step transitions, with fast detection. The first (e.g., inverting) input of the comparator 504 is coupled to the second terminal of the voltage source 508. The second (e.g., non-inverting) terminal of the comparator 504 is coupled to the second terminal of the resistor 206, the second input terminal of the multiplexer 210, and the first input terminal of the multiplexer 212. The output terminal of the comparator 504 is coupled to the polarity detection control circuitry 510.

In the example of FIG. 5, the first comparator 502 detects large current changes for a first direction of the sensed current (e.g., from the second sensor input terminal 204 to the first sensor input terminal 202). The second comparator 504 detects large current changes for a second direction of the sensed current (e.g., from the first sensor input terminal 202 to the first sensor input terminal 204).

The voltage sources 506, 508 adjust the voltage that is applied to the non-inverting input terminals of the comparators 502, 504. For example, the voltage source 506 adds a voltage (e.g., 3 mV) to the voltage at the second terminal of the resistor 206 before applying to the non-inverting input terminal of the comparator 502 and the voltage source 506 adds a voltage (e.g., 3 mV) to the voltage at the second terminal of the resistor 208 before applying to the non-inverting input terminal of the comparator 504. The amount of voltage corresponds to the blind zone. Accordingly, the comparators 502, 504 do no trigger a change in output unless the change is outside of the blind zone of the amplifier 213. The first terminal of the voltage source 506 is coupled to the second terminal of the resistor 206, the second input terminal of the multiplexer 210, the first input terminal of the multiplexer 212, and the second input terminal of the comparator 504. The first terminal of the voltage source 508 is coupled to the second terminal of the resistor 208, the first input terminal of the multiplexer 210, the second input terminal of the multiplexer 212, and the first input terminal of the comparator 502. The second terminal of the voltage source 506 is coupled to the second input terminal of the comparator 502. The second terminal of the voltage source 508 is coupled to the first input terminal of the comparator 504.

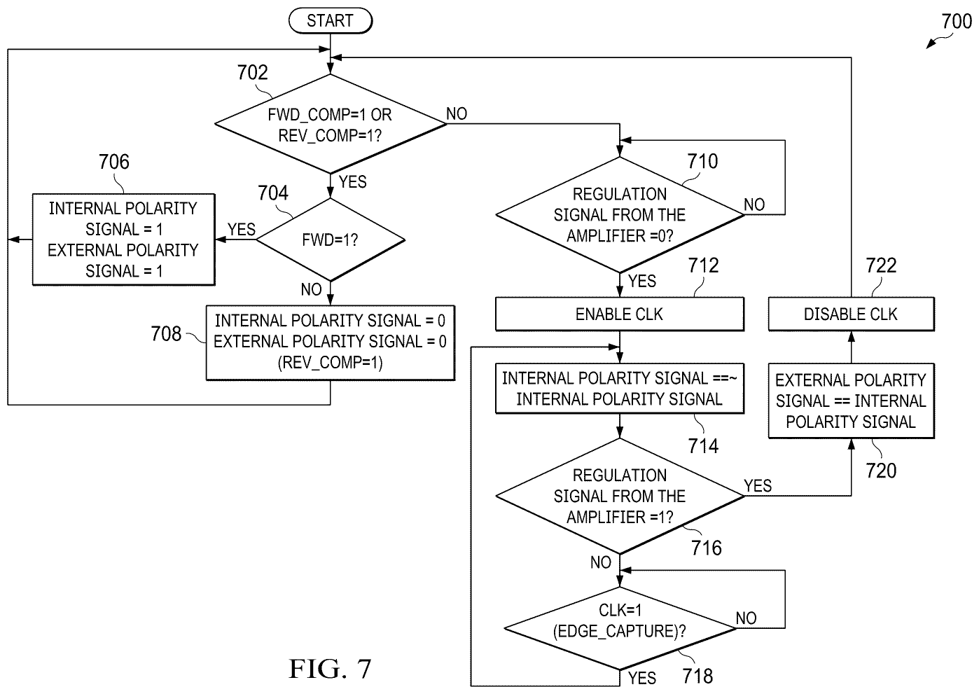

The polarity detection control circuitry 510 of FIG. 5 operates in a similar manner as the polarity detection control circuitry 302 of FIG. 3A. However, the polarity detection control circuitry 510 manages the outputs of the comparators 502, 504 to trigger polarity changes in particular situations. For example, the outputs of the comparators 502, 504 can operate as an interrupt signal causing the polarity detection control circuitry 510 to adjust the polarity output signal before the polarity is detected via the amplifier 213. Because the polarity detection control circuitry 510 toggles the polarity artificially when in the blind zone, in FIG. 5, the sensor polarity output terminal 512 is separate from the POLINT signal. In this manner, when the polarity detection control circuitry 510 is artificially toggling polarity while in the blind zone, the end user does not see the toggling. The first input of the polarity detection control circuitry 510 is coupled to the first current terminal of the transistor 216, the second input terminal of the driver 224, and the second terminal of the current source 220. The second input of the polarity detection control circuitry 510 is coupled to the first current terminal of the transistor 218 and the second terminal of the current source 222. The third input terminal of the polarity detection control circuitry 510 is coupled to a clock generated (e.g., located within or outside of the bidirectional sensor 300). The fourth input terminal of the polarity detection control circuitry 510 is coupled to the output terminal of the comparator 502. The fifth input terminal of the polarity detection control circuitry 510 is coupled to the output terminal of the comparator 504. The first output terminal of the polarity detection control circuitry 510 is coupled to the input of the polarity detection circuitries 223. The second output terminal of the polarity detection control circuitry 510 is coupled to the sensor polarity output terminal 512. The polarity detection control circuitry 510 may be implemented by any combination of software, hardware, or firmware. In some examples, the polarity detection control circuitry 510 is implemented by a state machine. In some examples, the polarity detection control circuitry 510 is implemented by a state machine. Example operations that may be implemented by any combination of software, hardware, or firmware to instantiate the polarity detection control circuitry 510 is further described below in conjunction with FIG. 7.

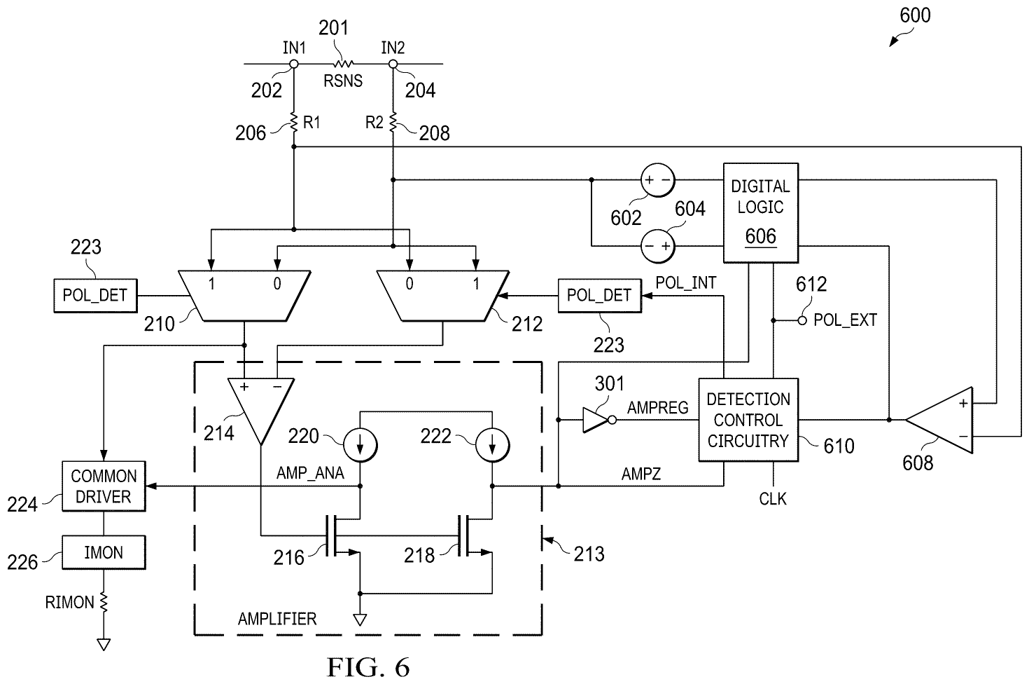

FIG. 6 is an example bidirectional current sensor 600. The bidirectional current sensor 600 is an example circuit implementation of one of the current sensors 120 of FIG. 1. FIG. 6 includes the sense resistor 201, the example sensor input terminals 202, 204, the example resistors 206, 208, the example multiplexers 210, 212, the example amplifier 213, the example first stage 214, the example transistors 216, 218, the example current sources 220, 222, the example driver 224, and the example sensor output terminal 226 of FIG. 2. FIG. 6 further includes example voltage sources 602, 604, an example digital logic 606, an example comparator 608, example polarity detection control circuitry 610, and an example sensor polarity output terminal 612.

In the example of FIG. 6 the two comparators 502, 504 are replaced with one comparator 608. However, the voltage adjustment to the first input terminal of the comparator 608 changes based on the output of the comparator 608 or the voltage at the AMP node. In this manner, the comparator 608 can detect large current changes in both directions by controlling the digital logic 606.

The voltage source 602 adjusts the voltage that is applied to the non-inverting input terminals of the comparator 608 when the first input of the digital logic 606 is connected to the first terminal of the comparator 608. For example, the voltage source 506 subtracts a voltage (e.g., 3 mV) to the voltage at the second terminal of the resistor 208 before applying to the non-inverting input terminal of the comparator 608. The amount of voltage corresponds to the blind zone. Accordingly, the comparator 608 does not trigger a change in output unless the change is outside of the blind zone of the amplifier 213. The first terminal of the voltage source 602 is coupled to the second terminal of the resistor 208, the first terminal of the multiplexer 210, the second terminal of the multiplexer 212, and the first terminal of the voltage source 604. The second terminal of the voltage source 602 is coupled to the first input terminal of the digital logic 606.

The voltage source 604 adjusts the voltage that is applied to the non-inverting input terminals of the comparator 608 when the first input of the digital logic 606 is connected to the second terminal of the comparator 608. For example, the voltage source 506 adds a voltage (e.g., 3 mV) to the voltage at the second terminal of the resistor 208 before applying to the non-inverting input terminal of the comparator 608. The amount of voltage corresponds to the blind zone. Accordingly, the comparator 608 does not trigger a change in output unless the change is outside of the blind zone of the amplifier 213. The first terminal of the voltage source 602 is coupled to the second terminal of the resistor 208, the first terminal of the multiplexer 210, the second terminal of the multiplexer 212, and the first terminal of the voltage source 602. The second terminal of the voltage source 602 is coupled to the second input terminal of the digital logic 606.

The digital logic 606 of FIG. 6 couples the first input terminal of the digital logic 606 to the output terminal of the digital logic 606 or the second input terminal of the digital logic 606 to the output terminal of the digital logic 606 based on the voltage at the select terminals of the digital logic 606. For example, when the output signal of the comparator 608 is a logic high voltage, the digital logic 606 output the In2 voltage plus the voltage of the voltage source 604 to the first input of the comparator 608. When the voltage at the In1 terminal becomes greater than the sum of the In2 terminal voltage plus the voltage source 604 voltage, the comparator 608 drops to a logic low voltage. When the voltage of the comparator 608 is a logic low voltage, the digital logic 606 outputs the In2 voltage minus the voltage source 602 voltage. When the In1 voltage drops lower than the In2 voltage minus the voltage source 602 voltage, the output voltage of the comparator 608 returns to a logic high voltage, thereby causing the digital logic 606 output the In2 voltage plus the voltage of the voltage source 604 to the first input of the comparator 608. If the AMPZ voltage is a logic high voltage, the digital logic 606 discards the output voltage of the comparator 608. The first input terminal of the digital logic 606 is coupled to the second terminal of the voltage source 602. The second terminal of the digital logic 606 is coupled to the second terminal of voltage source 604. The first select terminal of the digital logic 606 is coupled to the AMP node. The second select terminal of the digital logic 606 is coupled to the output of the comparator 608. The third select terminal of the digital logic 606 is coupled to the polarity detection control circuitry 610 and the sensor polarity output terminal 612. The output terminal of the digital logic 606 is coupled to a first input terminal (e.g., the non-inverting input terminal) of the comparator 608.

The comparator 608 of FIG. 6 compares the voltage at a first input of the comparator 608 to the voltage at a second input of the comparator 608 and outputs a voltage based on the comparison. For example, if the voltage at the first terminal (e.g., the non-inverting input terminal) of the comparator 608 is higher than the voltage at the second terminal (e.g., the inverting input terminal) of the comparator 608, the comparator 608 outputs a logic high voltage. Otherwise, the comparator 608 outputs a logic low voltage. The amount of time that the bidirectional current sensors 200, 300, 350 determine a large current polarity change is limited by the bandwidth of the amplifier 213. In the bidirectional current sensor 600 of FIG. 6, the comparator 608 can quickly react to a large current change in an opposite direction to indicate that the polarity has changed faster than the bandwidth of the amplifier 213. The comparator 608 compares (a) the sum or difference (e.g., depending on the select terminals of the digital logic 606) of (i) the second voltage at the second terminal of the resistor 208 and (ii) an offset voltage generated by the voltage source 506 with (b) the first voltage at the second terminal of the resistor 206. Accordingly, the comparator 608 detects large current changes (e.g., outside the blind zone), also referred to as large step transitions, with fast detection. The first (e.g., inverting) input of the comparator 608 is coupled to the second terminal of the voltage source 508. The second (e.g., non-inverting) terminal of the comparator 608 is coupled to the second terminal of the resistor 206, the second input terminal of the multiplexer 210, the first input terminal of the multiplexer 212. The output terminal of the comparator 608 is coupled to the polarity detection control circuitry 510.

The polarity detection control circuitry 610 of FIG. 6 operates in a similar manner as the polarity detection control circuitry 510 of FIG. 5. However, the polarity detection control circuitry 610 manages a single output from the comparator 608 instead of two outputs of the comparators 502, 504 to trigger polarity changes in particular situations. Because the polarity detection control circuitry 610 toggles the polarity artificially when in the blind zone, in FIG. 6, the sensor polarity output terminal 612 is separate from the POLINT signal. In this manner, when the polarity detection control circuitry 610 is artificially toggling polarity while in the blind zone, the end user does not see the toggling. The first input of the polarity detection control circuitry 610 is coupled to the first current terminal of the transistor 216, the second input terminal of the driver 224, and the second terminal of the current source 220. The second input of the polarity detection control circuitry 610 is coupled to the first current terminal of the transistor 218 and the second terminal of the current source 222. The third input terminal of the polarity detection control circuitry 610 is coupled to a clock generated (e.g., located within or outside of the bidirectional sensor 300). The fourth input terminal of the polarity detection control circuitry 610 is coupled to the output terminal of the comparator 608. The first output terminal of the polarity detection control circuitry 610 is coupled to the input terminal of the polarity detection circuitries 223. The second output terminal of the polarity detection control circuitry 610 is coupled to the digital logic 606 and the sensor polarity output terminal 612. The polarity detection control circuitry 610 may be implemented by any combination of software, hardware, or firmware. Example operations that may be implemented by any combination of software, hardware, or firmware to instantiate the polarity detection control circuitry 610 is further described below in conjunction with FIG. 7.

FIG. 7 is a flowchart representative of example machine-readable instructions or example operations 700 that may be at least one of executed, instantiated, or performed by programmable circuitry to control the polarity signal output to the polarity detection circuitries 223 and the sensor polarity output terminal (POLEXT) 304, 512, 612 of FIGS. 3A, 3B, 4, 5, or 6. In the flowchart of FIG. 7, FWD_COMP is the output of the comparator 504 or the output of the comparator 608 (e.g., when operating as a forward comparator). REV_COMP is the output of the comparator 502 or the output of the comparator 608 (e.g., when operating as a reverse comparator). The determination of whether the comparator 608 is operating as a forward comparator or a reverse comparator is based on the output of the comparator 608 and the AMPZ signal. AMPREG (also referred to as a regulation signal) is the inverse of the AMPZ signal and corresponds to whether the amplifier 213 is operating in regulation. CLK corresponds to the clock signal obtained by the polarity detection control circuitry 510, 610. POLINT corresponds to the internal polarity signal and POLEXT corresponds to the external polarity signal. POLINT may be a signal that is output to the polarity detection circuitry 223. POLEXT may be the signal that is output to the sensor polarity output terminal 304, 512, 612.

The example machine-readable instructions or the example operations 700 of FIG. 7 begin at block 702, at which the polarity detection control circuitry 510, 610 determines if the output of at least one of the comparators 502, 504, 608 is a logic high voltage (e.g., corresponding to a large polarity flip in the sensed current. If the polarity detection control circuitry 510, 610 determines that the output of at least one of the comparators 502, 504, 608 is not a logic high voltage (block 702: NO), the instructions continue to block 710, as further described below. If the polarity detection control circuitry 510, 610 determines that the output of the at least one of the comparators 502, 504, 608 is a logic high voltage (block 702: YES), the polarity detection control circuitry 510, 610 determines if the output of the comparator 504 (or comparator 608 while operating as a forward comparator) is a logic high voltage. Alternatively, the polarity detection control circuitry 510, 610 can determine if the output of the comparator 502 (or comparator 608 while operating as a reverse comparator) is a logic low voltage.

If the polarity detection control circuitry 510, 610 determines that the output of the comparator 504 (or comparator 608 while operating as a forward comparator) is a logic high voltage (block 704: YES), the polarity detection control circuitry 510, 610 outputs a logic high voltage to the polarity detection circuitries 223 and outputs a logic high voltage to the sensor polarity output terminal 304, 512, 612 (block 706). If the polarity detection control circuitry 510, 610 determines that the output of the comparator 504 (or comparator 608 while operating as a forward comparator) is not a logic high voltage (block 704: NO), the polarity detection control circuitry 510, 610 outputs a logic low voltage to the polarity detection circuitries 223 and outputs a logic low voltage to the sensor polarity output terminal 304, 512, 612 (block 708).

At block 710, the polarity detection control circuitry 510, 610 determines if the AMPREG signal at the AMPREG terminal corresponds to a logic low voltage (e.g., 0 V). In some examples, the polarity detection control circuitry 510, 610 determines if the AMPZ signal at the AMPZ terminal corresponds to a logic high voltage. When the AMPREG signal corresponds to 0 V, the amplifier 213 is operating out of regulation (e.g., as a comparator). Thus, at block 710, the polarity detection control circuitry 510, 610 is also determining if the amplifier 213 is out of regulation. If the polarity detection control circuitry 510, 610 determines that the AMPREG signal does not correspond a logic low voltage (block 710: NO), control returns to block 710 until the output of the amplifier 213 corresponds to a logic low voltage. If the polarity detection control circuitry 510, 610 determines that the AMPREG signal corresponds a logic low voltage (block 710: YES), the polarity detection control circuitry 510 enables the clock signal to initiate the toggling of the polarity signal output to the polarity detection circuitries 223 (block 712). At block 714, the polarity detection control circuitry 510, 610 changes the POLINT signal (e.g., the signal that is applied to the polarity detection circuitries 223) to the opposite of what the POLINT signal previously was.

At block 716, the polarity detection control circuitry 510, 610 determines if the amplifier 213 has returned to operating in regulation by determining if the AMPREG signal corresponds to a logic high voltage (or if the APZ signal corresponds to a logic low voltage). If the polarity detection control circuitry 510, 610 determines that the AMPREG signal corresponds to a logic high voltage (block 716: YES), control continues to block 720, as further described below. If the polarity detection control circuitry 510, 610 determines that AMPREG signal does not correspond to a logic high voltage (block 716: NO), the polarity detection control circuitry 510, 610 determines if the clock signal has raised from a logic low to a logic high (e.g., if a rising edge of a block has been detected) (block 718). If the polarity detection control circuitry 510, 610 determines that a rising clock edge has not been detected (block 718: NO), control returns to block 718 until a rising clock edge has been detected. If the polarity detection control circuitry 510, 610 determines that a rising clock edge has been detected (block 718: YES), control returns to block 714 and the process is repeated to continue to toggle the POLINT signal until the amplifier 213 returns to regulation.

At block 720, the polarity detection control circuitry 510, 610 the outputs the POLEXT signal to the sensor polarity output terminal 304, 512, 612 based on the POLINT signal that was applied to get the amplifier 213 into regulation. At block 722, the polarity detection control circuitry 510, 610 disable the clock signal. For example, the polarity detection control circuitry 510, 610 disable the clock signal to conserve power while the amplifier 213 is operating in regulation (e.g., operating as an amplifier). After block 722, control returns to block 702.

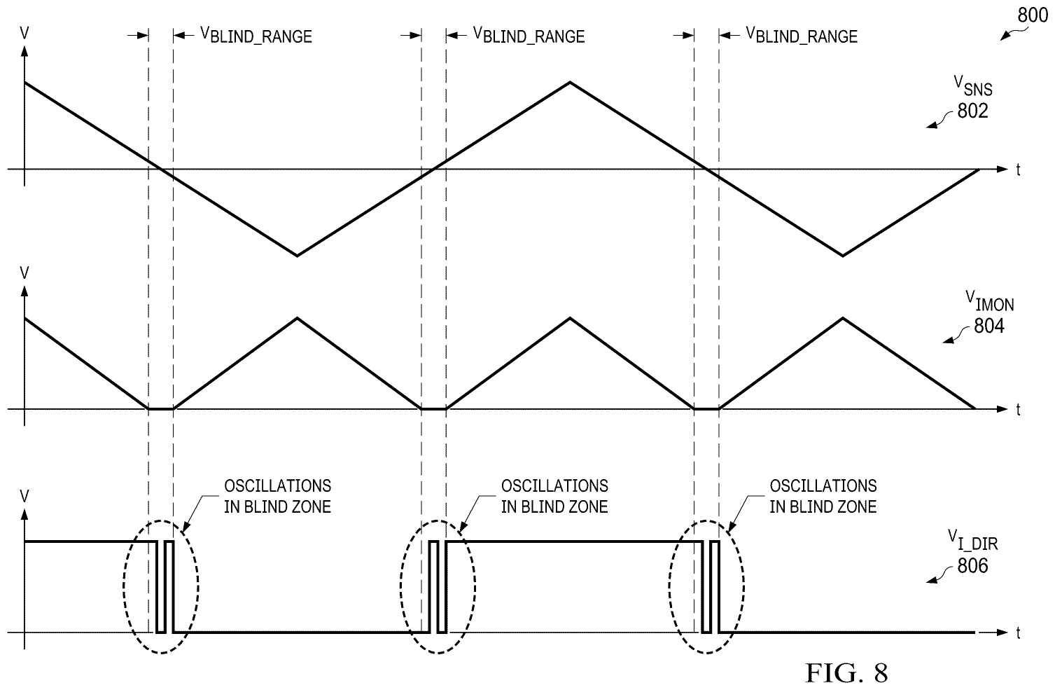

FIG. 8 illustrates an example graph 800 illustrating a transition of sensed current from a first direction to a second direction and back to a first direction without using examples disclosed herein. FIG. 8 includes an example current signal 802, an example sensed current signal 804, and an example polarity output voltage signal 806.

The current signal 802 corresponds to the actual current being sensed by the bidirectional current sensor not implementing examples disclosed herein. The sensed current signal 804 corresponds to the amount of current determined by the bidirectional current sensor that does not implement examples disclosed herein (e.g., which corresponds to the absolute value of the current signal 802). As shown in FIG. 8, when the current signal 802 is in a reverse direction (e.g., corresponding to a negative current), the polarity output voltage signal 806 is a logic low voltage corresponding to the negative current. When the current signal 802 increases to zero and then onto a current in a forward direction (e.g., corresponding to a positive current), the polarity output voltage signal 806 goes to a logic high voltage corresponding to a positive current. When the current signal 802 is within the blind zone of the amplifier 213, the polarity signal 806 toggles between a logic high and a logic low due to the mismatch between an amplifier and a comparator in bidirectional amplifiers that do not implement examples disclosed herein. Also, when the current 802 decreases back to zero and then onto a current in the reverse direction (e.g., corresponding to a negative current), the polarity output voltage signal 806 goes to a logic low voltage to correspond to a negative current. When the current signal 802 is within the blind zone of the amplifier 213, the polarity signal 806 toggles between a logic high and a logic low due to the mismatch between an amplifier and a comparator in bidirectional amplifiers that do not implement examples disclosed herein.

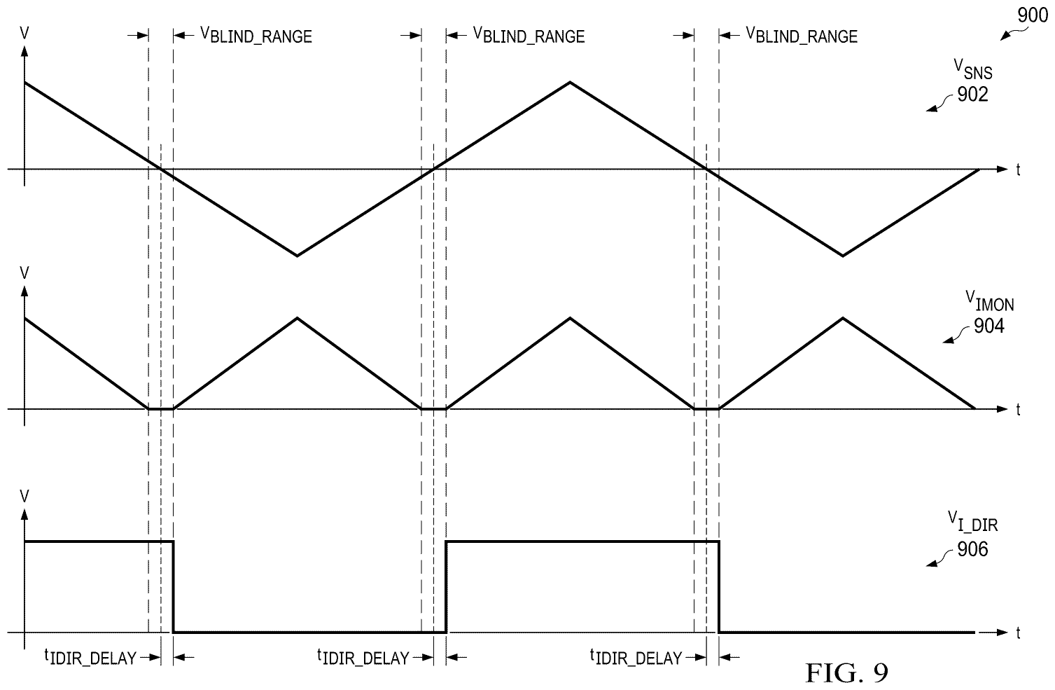

FIG. 9 illustrates an example graph 900 illustrating a transition of sensed current from a first direction to a second direction and back to a first direction using examples described herein. FIG. 9 includes an example current signal 902, an example sensed current signal 904, and an example polarity output voltage signal 906.

The example current signal 902 is the voltage across the sense resistors 201, which represents the current being sensed by the bidirectional current sensor 120, 200, 300, 500, 600 of FIGS. 1-3B, 5 and 6. The sensed current signal 904 is the voltage across an output resistor coupled to the sensor output terminal 226 of FIGS. 2, 3A, 3B 5, and 6, which represents the amount of current determined by the bidirectional current sensor 120, 200, 300, 500, 600 of FIGS. 1-3B, 5 and 6. The polarity output voltage signal 906 corresponds to the voltage at the sensor polarity output terminal 304, 512, 612 of FIGS. 3A, 3B, 5, or 6. As shown in the graph 900, when the current signal 902 gets close to zero, the amplifier 213 goes out of regulation within the blind zone and when the current signal 902 gets outside of the blind zone into the negative current region, the polarity output voltage signal 906 changes from a logic high to a logic low (e.g., to indicate that the polarity of the current signal 902 is negative), without the oscillations associated with the convention bidirectional current sensor, as shown in the graph 800 of FIG. 8.

While an example manner of implementing the bidirectional current sensor 120 of FIG. 1 is illustrated in FIGS. 2-6, one or more of the elements, processes, or devices illustrated in FIG. 2-6 may be combined, divided, re-arranged, omitted, eliminated, or implemented in any other way. Further, the polarity detection control circuitry 302, the polarity detection control circuitry 510, or polarity detection control circuitry 610, may be implemented by hardware alone or by hardware in combination with software and firmware. Thus, for example, any of the polarity detection control circuitry 302, the polarity detection control circuitry 510, or polarity detection control circuitry 610, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example the polarity detection control circuitry 302, the polarity detection control circuitry 510, or polarity detection control circuitry 610 of FIGS. 3-6 may include one or more elements, processes, or devices in addition to, or instead of, those illustrated in FIG. 2, or may include more than one of any or all of the illustrated elements, processes and devices.

Flowchart(s) representative of example machine-readable instructions, which may be executed by programmable circuitry to at least one of implement or instantiate the polarity detection control circuitry 510 or polarity detection control circuitry 610 of FIG. 5 or 6 or representative of example operations which may be performed by programmable circuitry to at least one of implement or instantiate the polarity detection control circuitry 510 or polarity detection control circuitry 610 of FIG. 5 or 6. The machine-readable instructions may be one or more executable programs or portion(s) of one or more executable programs for execution by programmable circuitry and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., at least one of software or firmware) stored on one or more non-transitory computer readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 7, many other methods of implementing the polarity detection control circuitry 510 or polarity detection control circuitry 610 of FIG. 5 or 6 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts responsive to being decrypted, decompressed, or combined from a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 7 may be implemented using executable instructions (e.g., computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

One or more example manners of implementing the bidirectional current sensor 120 of FIG. 1 is illustrated in FIGS. 2-6. However, one or more of the elements, processes or devices illustrated in FIGS. 1-6 may be combined, divided, re-arranged, omitted, eliminated or implemented in any other way.

Further, one or more of the polarity detection control circuitry 302, the polarity detection control circuitry 510 or polarity detection control circuitry 610 of FIGS. 3A, 3B, 5 or 6 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) or field programmable logic device(s) (FPLD(s)).

When reading any of the apparatus or system claims of this patent to cover a purely software or firmware implementation, at least one of the polarity detection control circuitry 302, the polarity detection control circuitry 510 or polarity detection control circuitry 610 of FIG. 3A,, 3B 5 or 6 is/are hereby expressly defined to include a non-transitory computer readable storage device or storage disk such as a memory, a digital versatile disk (DVD), a compact disk (CD), a Blu-ray disk, etc., including the software or firmware. Further still, the polarity detection control circuitry 302, the polarity detection control circuitry 510 or polarity detection control circuitry 610 of FIGS. 3A, 3B, 5 or 6 may include one or more elements, processes or devices in addition to, or instead of, those illustrated in FIGS. 5-6, or may include more than one of any or all of the illustrated elements, processes, and devices. As used herein, the phrase “in communication,” including variations thereof, encompasses direct communication or indirect communication through one or more intermediary components, and does not require direct physical (e.g., wired) communication or constant communication, but rather also includes selective communication at one or more of periodic intervals, scheduled intervals, aperiodic intervals, or one-time events.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein to identify multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for ease of referencing multiple elements or components.

In the description and in the claims, the terms “including” and “having,” and variants thereof are to be inclusive in a manner similar to the term “comprising” unless otherwise noted. Unless otherwise stated, “about,” “approximately,” or “substantially” preceding a value means +/−10 percent of the stated value. In another example, “about,” “approximately,” or “substantially” preceding a value means +/−5 percent of the stated value. IN another example, “about,” “approximately,” or “substantially” preceding a value means +/−1 percent of the stated value.

The terms “couple,” “coupled,” “couples,” and variants thereof, as used herein, may cover connections, communications, or signal paths that enable a functional relationship consistent with this description. For example, if device A generates a signal to control device B to perform an action, if a first example device A is coupled to device B, or if a second example device A is coupled to device B through intervening component C if intervening component C does not substantially alter the functional relationship between device A and device B, such that device B is controlled by device A via the control signal generated by device A. Moreover, the terms “couple,” “coupled”, “couples”, or variants thereof, includes an indirect or direct electrical or mechanical connection.

A device that is “configured to” perform a task or function may be configured (e.g., at least one of programmed or hardwired) at a time of manufacturing by a manufacturer to perform the function or may be configurable (or re-configurable) by a user after manufacturing to perform the function or other additional or alternative functions. The configuring may be through at least one firmware or software programming of the device, through a construction or layout of hardware components and interconnections of the device, or a combination thereof.

Although not all separately labeled in the FIGS. 1-6, components or elements of systems and circuits illustrated therein have one or more conductors or terminus that allow signals into or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on particular circuitry or system topology, there may be more or fewer terminals and nodes. However, in some instances, “terminal,”“node,”“interconnect,”“pad,”and “pin”may be used interchangeably.

The term “or” as used, for example, in a form such as A, B, or C refers to any combination or subset of A, B, C such as (1) A alone, (2) B alone, (3) C alone, (4) A with B, (5) A with C, (6) B with C, or (7) A with B and with C.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Modifications are possible in the described examples, and other examples are possible, within the scope of the claims.

1. A current sensor comprising:
a first sensor input terminal and a second sensor input terminal;
a first multiplexer including a first input terminal, a second input terminal, a select terminal, and an output terminal, the first input terminal of the first multiplexer coupled to the first sensor input terminal, the second input terminal of the first multiplexer coupled to the second sensor input terminal;
a second multiplexer including a first input terminal, a second input terminal, a select terminal, and an output terminal, the first input terminal of the second multiplexer coupled to the second input terminal of the first multiplexer, the second input terminal of the second multiplexer coupled to the first input terminal of the first multiplexer;
an amplifier including a first stage and a transistor, the first stage including a first input terminal, a second input terminal, and an output terminal, the first input terminal of the first stage coupled to the output terminal of the first multiplexer, the second input terminal of the first stage coupled to the output terminal of the second multiplexer, the transistor including a first current terminal, a second current terminal, and a control terminal, the control terminal of the transistor coupled to the output terminal of the first stage; and
polarity detection circuitry including an input terminal and an output terminal, the input terminal of the polarity detection circuitry coupled to the first current terminal of the transistor, the output terminal of the polarity detection circuitry coupled to at least one of the select terminal of the first multiplexer or the select terminal of the second multiplexer.

2. The current sensor of claim 1, further including:
a first resistor including a first terminal and a second terminal, the second terminal of the first resistor coupled to the first terminal of the first multiplexer and the first terminal of the second multiplexer; and
a second resistor including a first terminal and a second terminal, the second terminal of the second resistor coupled to the second terminal of the first multiplexer and the second terminal of the second multiplexer.

3. The current sensor of claim 1, wherein the transistor is a first transistor, further including a driver including a first input terminal, a second input terminal, and an output terminal, the first input terminal coupled to the output terminal of the first multiplexer, wherein the amplifier further includes a second transistor including a control terminal, a first current terminal, and a second current terminal, the control terminal coupled to the output terminal of the first stage, the first current terminal coupled to the second input terminal of the driver, and the second current terminal coupled to ground.

4. The current sensor of claim 1, further including polarity detection control circuitry, the first current terminal of the transistor coupled to the polarity detection circuitry via the polarity detection control circuitry.

5. The current sensor of claim 4, wherein the transistor is a first transistor, further including a second transistor including a control terminal, a first current terminal, and a second current terminal, the control terminal coupled to the output terminal of the first stage, wherein the polarity detection control circuitry includes:
a first logic gate including a first input terminal, a second input terminal, and an output terminal, the first input terminal of the first logic gate coupled to the first current terminal of the first transistor, the second input terminal to obtain a clock signal;
a delay circuitry including an input terminal and an output terminal, the input terminal coupled to the output terminal of the first logic gate;
an inverter including an input terminal and an output terminal, the input terminal of the inverter coupled to the first current terminal of the first transistor via a second inverter;
a second logic gate including a first input terminal and a second input terminal, the first input terminal of the second logic gate coupled to the output terminal of the inverter, the second input terminal of the second logic gate coupled to the output terminal of the delay circuitry; and
a flip flop including a first input terminal, a second input terminal, a first output terminal and a second output terminal, the first input terminal of the flip flop coupled to the output terminal of the second logic gate, the second input terminal of the flip flop coupled to the first output terminal of the flip flop, the second output terminal of the flip flop coupled to the input terminal of the polarity detection circuitry.

6. The current sensor of claim 4, wherein the transistor is a first transistor, further including a second transistor including a control terminal, a first current terminal, and a second current terminal, the control terminal of the second transistor coupled to the output terminal of the first stage.

7. The current sensor of claim 6, wherein the polarity detection control circuitry includes a first input terminal, a second input terminal, a third input terminal, a fourth input terminal, a fifth input terminal, and an output terminal, the first input terminal of the polarity detection control circuitry coupled to the first current terminal of the second transistor, the second input terminal of the polarity detection control circuitry coupled to the first current terminal of the first transistor, the third input terminal of the polarity detection control circuitry to obtain a clock signal, the output terminal of the polarity detection control circuitry coupled to the input terminal of the polarity detection circuitry, further including:
a first voltage source including a first terminal and a second terminal, the first terminal of the first voltage source coupled to the second input terminal of the first multiplexer and the first input terminal of the second multiplexer;
a second voltage source including a first terminal and a second terminal, the first terminal of the second voltage source coupled to the first input terminal of the first multiplexer and the second input terminal of the second multiplexer;
a first comparator including a first input terminal, a second input terminal, and an output terminal, the first input terminal of the first comparator coupled to the first input terminal of the first multiplexer and the second input terminal of the second multiplexer, the second input terminal of the first comparator coupled to the second terminal of the first voltage source, and the output terminal of the first comparator coupled to the fourth input terminal of the polarity detection control circuitry; and
a second comparator including a first input terminal, a second input terminal, and an output terminal, the first input terminal of the second comparator coupled to the second terminal of the second voltage source, the second input terminal of the second comparator coupled to the second input terminal of the first multiplexer and the first input terminal of the second multiplexer, and the output terminal of the second comparator coupled to the fifth input terminal of the polarity detection control circuitry.

8. The current sensor of claim 6, wherein the polarity detection control circuitry includes a first input terminal, a second input terminal, a third input terminal, a fourth input terminal, and an output terminal, the first input terminal of the polarity detection control circuitry coupled to the first current terminal of the second transistor, the second input terminal of the polarity detection control circuitry coupled to the first current terminal of the first transistor, the third input terminal of the polarity detection control circuitry to obtain a clock signal, the output terminal of the polarity detection control circuitry coupled to the input terminal of the polarity detection circuitry, further including:
a first voltage source including a first terminal and a second terminal, the first terminal of the first voltage source coupled to the first input terminal of the first multiplexer and the second input terminal of the second multiplexer;
a second voltage source including a first terminal and a second terminal, the first terminal of the second voltage source coupled to the first input terminal of the first multiplexer and the second input terminal of the second multiplexer;
digital logic including a first input terminal, a second input terminal, a first select terminal, a second select terminal, and an output terminal, the first input terminal coupled to the second input terminal of the first voltage source, the second input terminal coupled to the second input terminal of the second voltage source, the first select terminal of the digital logic is coupled to the first current terminal of the second transistor; and
a comparator including a first input terminal, a second input terminal, and an output terminal, the first input terminal of the comparator coupled to the output terminal of the digital logic, the second input terminal of the comparator coupled to the second input terminal of the first multiplexer and the first input terminal of the second multiplexer, and the output terminal of the comparator coupled to the fourth input terminal of the polarity detection control circuitry and the second select terminal of the digital logic.

9. An apparatus comprising:
a first input terminal, a second input terminal, and an output terminal;
an amplifier including a first input terminal and a second input terminal;
a multiplexer configured to:
connect the first input terminal to the first input terminal of the amplifier based on a polarity signal being a first voltage, the polarity signal corresponding to a direction of a first current; and
connect the second input terminal to the first input terminal of the amplifier based on the polarity signal being a second voltage; and
the amplifier configured to:
based on (a) the first current between the first input terminal and the second input terminal flowing in a first direction and (b) the multiplexer connection the first input terminal to the first input terminal of the amplifier, operate as an amplifier to cause sinking of a second current through the output terminal; and
after the first current changes to a second direction opposite the first direction, operate as a comparator to cause the polarity signal to change to the second voltage.

10. The apparatus of claim 9, wherein the second current corresponds to an amount of the first current.

11. The apparatus of claim 9, wherein the amplifier is to cause the sinking of the second current through the output terminal by generating an output voltage that that regulates a loop to provide a scaled version of a difference between a third voltage corresponding to the first input terminal to a fourth voltage corresponding to the second input terminal, further including:
a driver to sink the second current through the output terminal based on a control signal; and
a transistor to generate the control signal based on the output voltage.

12. The apparatus of claim 9, further including polarity detection control circuitry to, based on an amount of the first current being within a range of currents, toggle the polarity signal between a logic low voltage and a logic high voltage based on a clock signal until the first current is outside of the range of currents.

13. The apparatus of claim 12, wherein the range of currents corresponds to a blind zone of the amplifier.

14. The apparatus of claim 9, further including a comparator configured to adjust the polarity signal based on a difference between a third voltage at the first input terminal and a fourth voltage at the second input terminal satisfying a threshold.

15. The apparatus of claim 9, wherein the amplifier is configured to control a switch based on at least one of the polarity signal and an amount of the sinking current at the output terminal.

16. A system comprising:
a first battery configured to provide first power to a load;
a second battery configured to provide second power to the load;
a switch coupled to the first battery and the second battery, the switch configured to, based on a control signal, connect or disconnect at least one of the first battery from the load or the second battery from the load; and
a current sensor to generate the control signal, the current sensor including:
a first sensor input terminal and a second sensor input terminal; and
an amplifier configured to:
operate as an amplifier to determine an amount of current between the first sensor input terminal and the second sensor input terminal; and
operate as a comparator to determine a direction of the current between the first sensor input terminal and the second sensor input terminal, the control signal corresponding to at least one of the amount of current or the direction of the current.

17. The system of claim 16, further including a power converter, the switch coupled to the first battery via the power converter.

18. The system of claim 16, wherein the amplifier is configured to:
operate as an amplifier when the current corresponds to a first direction; and
after the current changes to a second direction opposite the first direction, operate as a comparator, wherein the amplifier operating as a comparator causes the amplifier to return to operating as an amplifier, further including a multiplexer configured to couple one of the first sensor input terminal or the second sensor input terminal to an input terminal of the amplifier, wherein the amplifier is configured to control the multiplexer based on the direction of the current.

19. A current sensor comprising:
a first input terminal and a second input terminal;
an amplifier including a first input terminal and a second input terminal;
polarity detection circuitry to output a polarity signal based on an output of the amplifier, the output of the amplifier corresponding to whether the amplifier is in regulation;
a first multiplexer configured to:
connect the first input terminal (202) to the first input terminal (+) of the amplifier based on the polarity signal being a first voltage (high), the polarity signal corresponding to a direction of a current between the first input terminal and the second input terminal; and
connect the second input terminal (204) to the first input terminal (+) of the amplifier based on the polarity signal being a second voltage (low); and
a second multiplexer to:
connect the first input terminal to the second input terminal of the amplifier based on the polarity signal being the second voltage; and
connect the second input terminal to the second input terminal of the amplifier based on the polarity signal being the first voltage.

20. The current sensor of claim 19, further including:
a first resistor, the first input terminal coupled to the first multiplexer via the first resistor; and
a second resistor, the second input terminal coupled to the first multiplexer via the second resistor.

21. (canceled)

22. (canceled)

23. (canceled)

24. (canceled)

25. (canceled)

26. (canceled)
